(19) United States
(12) Patent Application Publication
(10) Pub. No.: US 2014/0354405 A1
(43) Pub. Date: Dec. 4, 2014

(54) Federated Biometric Identity Verifier

(71) Applicant: Secure Planet, Inc., Arlington, VA (US)

(72) Inventors: Robert Kocher, McLean, VA (US); David Simon, Alexandria, VA (US); Henry Heidt, Vienna, VA (US); Bill Hanczaryk, Crofton, MD (US)

(73) Assignee: SECURE PLANET, INC., Arlington, VA (US)

(21) Appl. No.: 14/049,150

(22) Filed: Oct. 8, 2013

Related U.S. Application Data
(60) Provisional application No. 61/881,273, filed on Sep. 23, 2013.
(60) Provisional application No. 61/829,331, filed on May 31, 2013.

(51) Int. Cl. G06F 21/32

(52) U.S. Cl. CPC G06F 21/32
USPC 340/5.82

(57) ABSTRACT

A federated biometric identity verification system that allows biometric verification of individuals across multiple organizations without sharing access to database content between those organizations. Multiple biometric application databases are securely networked together using public-key infrastructure techniques. Biometric information is collected from a subject, and segregated into applicable subsets or modalities, and searchable templates are generated. The templates are encrypted and searched against each database securely without requiring the comingling of database content. Results are returned for each database searched consistent with the characteristics authorized by the organization controlling the database. No further access to the database is allowed.

### CROSS-REFERENCE TO RELATED APPLICATION

This application claims the benefit of U.S. provisional patent application No. 61/829,331 filed on May 31, 2013 and U.S. provisional patent application No. 61/881,273 filed on Sep. 23, 2013.

### BACKGROUND

The subject matter of this specification relates to the field of searching biometric information for the purposes of identification and verification.

Organizations such as schools, hospitals, businesses, and government agencies often go to great lengths to assess the trustworthiness of their personnel. This is commonly done because their personnel may have access to confidential information that is valuable to the organization or because of the security threat non-trustworthy personnel can pose to the organization. In order to meet these assurance goals, organizations increasingly maintain biometric identification systems. A biometric identification system is a system of records containing biometric information associated with individuals, which allows for highly accurate identification of those individuals based on the associated biometric information. Typically, a biometric identification system is comprised of a database of biometric records and searching software that allows collected biometric information to be searched against the database. Biometric identification systems may be used to support a variety of identification functions, including physical access control, network access control, encounter tracking, and the detection of persons of interest.

Organizations frequently work in combination under circumstances where personnel from multiple organizations need to access sensitive information possessed by only one organization, or where the participation in the combined effort puts all organizations under the risk of violent attack. Under these circumstances each organization continues to have a strong interest in assessing the trustworthiness of their personnel; however each organization also has an equally strong interest in assessing the trustworthiness of the personnel of the other organizations participating in the joint effort. Unfortunately, for security, competitive, or legal reasons, separate organizations typically will not share access to their biometric records. There may be laws against the disclosure of personally identifiable information or circumstances where the mere knowledge that a certain individual is part of a given organization may compromise that individual's ability to function effectively. Moreover, each organization's biometric identification system frequently will not be technically compatible with the biometric identification systems of the other participating organizations. Often this is because the biometric template standard of one system is different than the other or is based on a different biometric modality (e.g. fingerprint versus iris). Although each participating organization may trust the other to the degree necessary to participate in the joint effort, each functions, in effect, as a separate non-trusted organization.

One example of two cooperating non-trusted organizations is the participation of U.S. Forces in the Republic of Korea (“South Korea”). In South Korea, the Republic of Korea Army maintains several shared military facilities in partnership with U.S. Forces. Each country manages its own biometric identification system for admitting authorized personnel into the shared facilities. The two organizations trust each other's vetting processes, but neither country enables access to the other's system due to national security concerns. As a result, each organization maintains separate biometric identification systems at each facility. This results in personnel being enrolled in both systems and vetted twice each time they enter. Two sets of biometric information must be captured using two separate devices and searched against two separate biometric identification systems, returning two separate results.

The obvious inefficiencies described above characterize the most basic multi-organizational biometric identification activities. Inefficiencies attributable to multiple enrollments, differing biometric modalities, differing search algorithms, and a lack of data-sharing continue to multiply as the number and diversity of participating organizations increases. What is needed is a mechanism to establish a trust relationship between the biometric identification systems of multiple participating organizations. Specifically, what is needed is a mechanism that enables comprehensive searching of multiple highly secure biometric identification systems, while avoiding the security, competitive, and legal risks that currently prevent organizations from integrating such systems.

### SUMMARY

The security, competitive, legal, and technical problems discussed above are solved by a system that conducts federated searches on a plurality of biometric identification systems where federated trust is established through Public-Key Infrastructure-based (“PKI”) techniques. In one embodiment, the system comprises a plurality of computing components, each controlled by a separate participating organization. The plurality of computing components are selected from the group consisting of a virtual machine and a computer (a physical machine). Each computer has at least one processor and at least one storage device. The plurality of computing components may be all virtual machines, all computers, or a combination of virtual machines and computers. The system may be implemented on a single physical machine where one computing component is the computer and each of the one or more additional computing components are virtual machines implemented on the computer. Each computing component is operatively connected to each other computing component over a communications network, which supports a protocol for encrypted communications and may be either physical or virtual. Where one or more virtual machines are implemented there will also be at least one hypervisor component. Each of the plurality of computing components is associated with one or more public/private key pairs, and at least one of the plurality of computing components is operatively connected to a biometric collector. In addition, the system comprises a plurality of biometric application databases, each stored in a storage device and each associated with a separate computing component of the plurality of computing components.

In this embodiment a first computing component of the plurality of computing components stores the one or more public keys of each other computing component of the plurality of computing components, and each other computing component of the plurality of computing components stores the one or more public keys of the first computing component.

A processor operable by the first computing component executes a first program code stored in a storage device accessible by the first computing component for: collecting a set of biometric information from a subject through the at least one biometric collector, encrypting the set of biometric information with the public key associated with each of the other computing components, transmitting each encrypted set of biometric information and a search request to each other computing component associated with each applicable public key, and decrypting the results received from each of the other computing components with the private key associated with the first computing component.

A processor operable by each other computing component executes a second program code stored in a storage device accessible by each other computing component for: decrypting the search request and biometric information transmitted by the first computing component using the private key associated with each respective other computing component, searching the set of biometric information against the database associated with each respective other computing component, encrypting the results of the search with the public key of the first computing component, and transmitting the encrypted results to the first computing component.

It should be noted that in some embodiments the second program code may alternatively be executed by a processor operable by the first computing component. Additionally, either the first computer code or second computer code (or both) may be stored in storage devices not contained on the same physical machine as the processor that executes the program code. In such an embodiment the code may be stored on one or more physically remote storage devices before being transmitted to and executed by the processor operable by a computing component.

This specification also discloses a computer implemented method and a computer program product for conducting federated searches on a plurality of biometric identification systems where federated trust is established through PKI-based techniques.

In one embodiment the method is for federated biometric verification performed by a processor operable by a first computing component, comprising: collecting a set of biometric information from a subject through at least one biometric collector, encrypting, with a public key associated with each of one or more other computing components, the set of biometric information, transmitting each encrypted set of biometric information and a search request to each other computing component associated with each applicable public key, and decrypting the results received by each of the other computing components with the public key associated with each of the other computing components; and a second program code executable by a processor operable by each other computing component for: decrypting the search request and biometric information transmitted by the first computing component using a private key associated with each other respective computing component, searching the set of biometric information against a database associated with each other respective computing component, encrypting the results of the search with a public key associated with the first computing component, and transmitting the encrypted results to the first computing component.

All or part of the methods described herein may be implemented as a computer program product that is a non-transitory computer-readable storage medium encoded with computer code that is executable by a processor.

The details of one or more embodiments of the subject matter of this specification are set forth in the drawings and descriptions contained herein. Other features, aspects, and advantages of the subject matter will become apparent from the description, drawings, and claims.

### DESCRIPTION OF THE SEVERAL VIEWS OF THE DRAWINGS

FIG. 1 is a system diagram depicting the core physical machine functionality and operating system functionality of a computer.

FIG. 2 is a system diagram depicting functional components of the biometric search application.

FIG. 3 is a system diagram depicting an embodiment implemented across a plurality of computing components that are each computers.

FIG. 4 is a system diagram depicting an embodiment implemented across a plurality of computing components, each of which are virtual machines implemented on a single computer.

FIG. 5 is a system diagram depicting an embodiment implemented across a plurality of computing components, one of which is a computer and one of which is a virtual machine implemented on the computer.

FIG. 6 is a screen mockup depicting an operator authentication interface.

FIG. 7 is a screen mockup depicting an operator user interface for submitting biometric searches and viewing the returned search results.

FIG. 8 is a screen mockup depicting operator user interface functionality for managing PKI certificates.

FIG. 9 is a screen mockup depicting operator user interface functionality for configuring local and remote biometric application databases.

FIG. 10 is a system diagram depicting PKI certificate hierarchies for two different participating organizations.

FIG. 11 is a flow diagram depicting a validation subroutine for validating and associating PKI database certificates with local and remote biometric application databases.

FIG. 12 is a flow diagram depicting a biometric segregation subroutine.

FIG. 13 is a flow diagram depicting a template creation subroutine.

FIG. 14 is a flow diagram depicting a biometric search subroutine performed across a plurality of computing components.

FIG. 15 is a flow diagram depicting the system operation across a plurality of computing components, at least one of which is a virtual machine.

FIG. 16 is a flow diagram depicting a result authorization subroutine.

### DETAILED DESCRIPTION

The subject matter of this specification functions in a variety of component combinations and contemplates all those types of components a person of ordinary skill in the art would find suitable for functions performed. The figures describe specific components in specific embodiments. However the range of the types of components mentioned in the description of the figures may be applied to other embodiments as well.

The terminology used herein is for the purpose of describing particular embodiments only and is not intended to be limiting. As used herein, the singular forms “a,” “an,” and “the” are intended to include the plural forms as well, unless the context clearly indicates otherwise. The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The subject matter of this specification is described below with reference to system diagrams, flow diagrams, and screen mockups of systems, methods, and computer program products. Except where used in the claims, the term “system” refers broadly to the subject matter of this specification, including embodiments that are, systems, methods, or computer program products. Each block or combinations of blocks in the diagrams can be implemented by computer program code and may represent a module, segment, or portion of code. Program code may be written in any combination of one or more programming languages, including object oriented programming languages such as the JAVA®, SMALLTALK®, C++, C#, OBJECTIVE-C® programming languages and conventional procedural programming languages, such as the “C” programming language.

It should be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block or combination of blocks in the diagrams can be implemented by special purpose hardware-based systems that perform the specified functions or acts.

Computer program code may be provided to a processor or multiple processors of a computer to produce a particular machine, such that the program code, which executes via the processor, creates means for implementing the functions specified in the system diagrams, flow diagrams, and screen mockups.

The subject matter of this specification is implemented on one or more physical machines. Each physical machine is a computer comprising one or more processors and one or more storage devices; however a single processor and a single storage device are sufficient. A person of ordinary skill in the art will recognize the variety of types of computers suitable for the functions described, including desktops, laptops, handset devices, smartphones, tablets, servers, or accessories incorporating computers such as watches, glasses, or wearable computerized shoes or textiles. A non-exhaustive list of specific examples of computers includes the following: Dell ALIENWARE™ desktops, Lenovo THINKPAD® laptops, SAMSUNG™ handsets, Google ANDROID™ smartphones, Apple IPAD® tablets, IBM BLADECENTER® blade sewers, PEBBLE™ wearable computer watches, Google GLASS™ wearable computer glasses, or any other device having one or more processors and one or more storage devices, and capable of functioning as described in this specification.

A processor may be any device that accepts data as input, processes it according to instructions stored in a storage component, and provides results as output. A person of ordinary skill in the art will recognized the variety of types of processors suitable for the functions disclosed, including general purpose processing units and special purpose processing units. A non-exhaustive list of specific examples of processors includes the following: Qualcomm SNAPDRAGON™ processors; Nvidia TEGRA® 4 processors; Intel CORE™ i3, i5, and i7 processors; TEXAS INSTRUMENTS™ OMAP4430; ARM® Cortex-M3; and AMD OPTERON™ 6300, 4300, and 3300 Series processors. Each computer may have a single processor or multiple processors operatively connected together (e.g. in the “cloud”).

A storage device is any type of non-transitory computer readable storage medium. A person of ordinary skill in the art will recognized the variety of types of storage devices suitable for the functions disclosed, including any electronic, magnetic, optical, electromagnetic, infrared, or semiconductor system or device, so long as it does not reduce to a transitory or propagating signal. A non-exhaustive list of specific examples of storage devices includes the following: portable computer diskettes, hard disks, random access memory, read-only memory, erasable programmable read-only memory, flash memory, optical fibers, portable compact disc read-only memory, optical storage devices, and magnetic storage devices. Each computer may have a single storage device or multiple storage devices operatively connected together (e.g. in the “cloud”).

This system may be implemented on one or more computers running one or more instances of a virtual machine. A virtual machine is a software implementation of a computer that executes programs like a physical machine. Thus a single physical machine may function conventionally as a physical computer, while also implementing a virtual machine that can perform the same processes as the physical computer. Multiple instances of a virtual machine may run on one computer or across multiple computers. A person of ordinary skill in the art will recognize the variety of types of virtual machines suitable for the functions disclosed, including system level virtual machines, process level virtual machines, fictive computers, and distributed computers. A non-exhaustive list of specific examples of virtual machines includes the following: VMWARE® virtual machines and Oracle VM VIRTUALBOX™ virtual machines.

Embodiments of this system that employ virtual machines may contain a hypervisor, which is also known as a virtual machine monitor. A hypervisor is a piece of computer software that creates, runs, and manages virtual machines. More than one virtual machine may be run by a single hypervisor. The hypervisor controls the utilization of one or more processors by one or more virtual machines and the utilization of one or more storage devices by one or more virtual machines. A person of ordinary skill in the art will recognized the variety of types of hypervisors suitable for the functions disclosed, including type one or “native” hypervisors, and type two or “hosted” hypervisors. A non-exhaustive list of specific examples of hypervisors includes: Oracle VMWARE® Sewer for SPARC, Oracle VM SERVER™ for x86, Citrix XENSERVER™, and VMWARE® ESX/ESXi.

For the purposes of this specification, the term “computing component” means a computer, a virtual machine, or multiple computers or virtual machines functioning as a single component. The term “computer” is limited to physical machines. Generally a computer functions as a computing component by implementing an operating system through which program code, which implements the methods of this system, is executed. Generally, when a virtual machine functions as a computing component, a computer implements a hypervisor which implements a separate operating system, through which the program code is executed.

As referenced above, a single computer may implement multiple computing components, wherein the computer itself functions as a computing component and concurrently implements one or more instances of a virtual machine. Each virtual machine functions as a separate computing component. Similarly, a plurality of computing components may be made up of separate computers, none of which implement a virtual machine, or a plurality of computing components may be implemented on a single computer wherein only the virtual machines function as computing components. Additional combinations are contemplated as well, such as where a computing component is implemented across multiple computers. For example, a hypervisor of a virtual machine may manage the processors and storage devices of three computers to implement a virtual machine that functions as a single computing component. A person of ordinary skill in the art will recognize the range of combinations of computers and virtual machines that are suitable for the functions disclosed.

Each of the plurality of computing components, whether implemented as separate computers or on a single computer, are operatively connected to one another, such as by a communications network. One skilled in the art will recognize the appropriate media over which multiple computing components may be operatively connected to each other in a manner suitable for the functions disclosed, including as a communications network that allows the computing components to exchange data such that a process in one computing component is able to exchange information with a process in another computing component. The communications network may also be a virtual communications network managed by a hypervisor. A non-exhaustive list of specific examples of transmission media includes: serial or parallel bus systems, wireless, wireline, twisted pair, coaxial cable, optical fiber cable, radio frequency, microwave transmission, or any other electromagnetic transmission media. In addition computing components can be operatively connected using secure socket layer or HTTPS communications networks employing PKI techniques as described below.

The system allows for the collection of a set of biometric information from a subject. Biometric information is a distinctive, measurable, physiological and behavioral characteristic of an individual. A person of ordinary skill in the art will recognize the range of biometric information that can be collected and included in a set of biometric information suitable for the functions disclosed. A non-exhaustive list of specific examples of biometric information includes: iris, fingerprint, fingernail, hand, knuckle, palm, vascular, face, retina, deoxyribonucleic acid, odor, earlobe, sweat pore, lips, signature, keystroke, voice, eye vein, and gait. A set of biometric information may consist entirely of one biometric type or modality, or multiple types or modalities.

The system collects the set of biometric information through one or more biometric collectors operatively connected to one or more of the plurality of computers. A person of ordinary skill in the art will recognize the range of biometric collection devices that are suitable to collect biometric information, including fingerprint readers, iris scanners, facial recognition imagers, and DNA samplers. A non-exhaustive list of specific examples of biometric collectors include the Futronic's FS88 USB 2.0 fingerprint scanner, FBI FIPS 201 compliant fingerprint scanners, AOPTIX STRATUS™ iris scanners, FBI FIPS compliant iris scanners, the BI2 MORIS™ facial recognition device, the Bode Technology BUCCAL DNA COLLECTOR™, L-1 Identity Solution's HIIDE™ device, Secure Planet's BRAVE™ system, SRI International's IRIS ON THE MOVE® systems, and Bayometric Inc.'s voice authentication system.

Records of biometric information associated individuals are stored as biometric application databases in one or more storage devices. Databases are organized collections of data and include software applications that allow for the definition, creation, querying, update, and administration of the organized collections of data. A person of ordinary skill in the art will recognize the range of types of databases suitable for functions disclosed, including active databases, cloud databases, distributed databases, federated database systems, and unstructured database systems. A non-exhaustive list of specific examples of databases includes: MySQL, PostgreSQL, SQLite, MICROSOFT® SQL Server, Microsoft Access, Oracle, SAP, and IBM DB2.

Communication between computing components may be encrypted using PKI techniques. For the purposes of this application the term “PKI techniques” includes all asymmetrical encryption techniques that create a trust relationship between participating organizations whereby a key pair is issued to the participating organizations. PKI techniques are well known in the art and generally depend on the fact that certain mathematical computations that are easy to compute in one direction are extremely difficult to compute in the other direction. A person of ordinary skill in the art will recognize the range of algorithms than are suitable for employing PKI techniques, including the algorithm developed by Ron Rivest, Adi Shamir, and Len Adelman of the Massachusetts Institute of Technology, known as the RSA algorithm. (The RSA algorithm is frequently employed in Secure Socket Layer techniques and HTTPS.) The RSA algorithm relies on the fact that it can be relatively easy to multiply large prime numbers together but almost impossible to factor the resulting product. Another example of PKI techniques is elliptic curve cryptography, which is based on the algebraic structure of elliptic curves over finite fields.

PKI techniques allow pairs of keys to be generated that can be used to encrypt data or digitally sign data. One of the keys is called a “public key” and the other a “private key” (collectively the key pair is a “public/private key pair”). Distribution of the private key is kept limited whereas the public key can be distributed freely. Data encrypted using the public key can only be reasonably decrypted by using the private key. This provides a mechanism whereby data can be transmitted over public networks in secret and can only be decrypted by the holder of the private key. Conversely, data encrypted using the private key can be decrypted by anyone holding the public key, but, crucially, any data which can be decrypted by the public key can only reasonably have been encrypted using the private key. This provides a mechanism whereby the holder of the private key can digitally sign data for transmission over a public network (such as by means of a “hash”) in such a way that anyone who holds the public key can verify that the data originates from the holder of the private key and that the data has not been modified since encryption. Further discussion of digital signatures is set forth below.

Providers of public/private key pairs are called “certificate authorities” because the public/private key pairs can be stored on a participating computer as a certificate. PKI certificates are stored in the storage devices accessible by the computing components. A non-exhaustive list of certificate authorities includes: Casidian Communications, DIGICERT® Inc. services, Entrust, Operational Research Consultants, Inc., Google, VERISIGN® services, SYMANTEC™ services, and VERIZON® services.

Participating organizations will generally desire to employ PKI techniques to establish a trust relationship amongst each other. This requires the participating organizations to first agree on a root certificate authority who will issue public/private key pairs to each organization. A root certificate authority, sometimes called a root authority, is meant to be the most trusted type of certificate authority in an organization's PKI. Typically, both the physical security and the certificate issuance policy of a root certificate authority are more rigorous than those for subordinate certificate authorities. If the root certificate authority is compromised or issues a certificate to an unauthorized entity, then any certificate-based security in your organization is immediately vulnerable. While root certificate authorities can be used to issue certificates to end users for such tasks as sending secure e-mail, in most organizations they will only be used to issue certificates to other certificate authorities, called subordinate certificate authorities. A subordinate certificate authority is a certificate authority that has been certified by another certificate authority in your organization. Typically, a subordinate certificate authority will issue certificates for specific uses, such as secure e-mail, web-based authentication, or smart card authentication. Subordinate certificate authorities can also issue certificates to other, more subordinate certificate authorities. Together, a root certificate authority, the subordinate certificate authorities that have been certified by the root certificate authority, and subordinate certificate authorities that have been certified by other subordinate certificate authorities form a certification hierarchy. A PKI certificate commonly contains information identifying the owner of the certificate, an identifier of the central authority that issued the certificate, a unique serial number, a validity date range, and other optional fields that indicate how the certificate can be used.

In cryptography, X.509 is an ITU-T standard for PKI and Privilege Management Infrastructure (“PMI”). X.509 specifies, amongst other things, standard formats for public key certificates, certificate revocation lists, attribute certificates, and a certification path validation algorithm. In addition such information may include a public key that is owned by the certificate owner and a field describing the hash and encryption functions used to create the digital signature of the certificate. A “hash” is the output of a function that takes an arbitrary block of data and returns a fixed-size bit string (the hash) such that any change to the source data will (with very high probability) change the hash value. The digital signature is an encrypted one-way hash of the certificate contents. This signature is created using the private key of either the certificate owner or, for certificates issued by an intermediate or root certificate, the private key of the intermediate or root certificate. The above describes a specific example of certificate verification; however a person of ordinary skill in the art will recognized the range of certificate verification techniques suitable for the functions described.

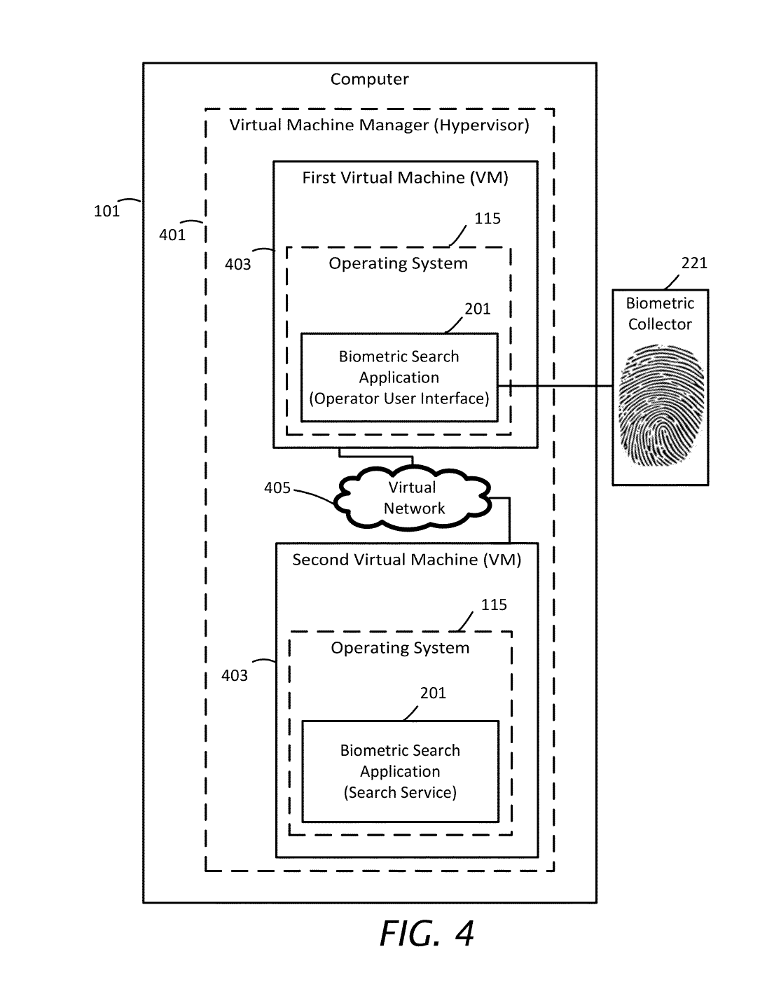

Certificate validation commonly involves verifying that the start and expiration date stored in the certificate are valid and have not expired and that the certificate format is valid and does not contain information fields that are improper or invalid. The certificate's digital signature is compared to a calculated hash of the certificate using the certificate's public key to verify that the certificate has not been tampered with or corrupted. Further discussion of the certificate validation process is set forth below in the description of FIG. 4.

Once the participating organizations have agreed on one or more certificate authorities, they may exchange public keys to create a trust relationship. The establishment of a trust relationship enables secure, encrypted communications between all computing devices controlled by all participating organizations.

Participating organizations will also typically desire to require an authenticated operator to initiate the system before it will perform searching functions. For example, an operator can be required to biometrically verify her identity as a trusted operator with one or more of the participating organizations in addition to providing a token, password, or other form of authenticating information. This type of operator identification would proceed in a similar manner to the biometric search process described below for a subject; however database(s) searched against will normally (but not necessarily) be distinct from the broader databases of biometric information. A person of ordinary skill in the art will recognize the range of credentials and authentication techniques suitable to authenticate the operator, including single or multi-factor authentication. A non-exhaustive list of authentication techniques includes: USB tokens (e.g. smart cards), usernames and passwords, and biometric authentication.

It should be noted that operator authentication is not necessary for the system to function, and embodiments without authentication may be desirable under certain circumstances. In a non-authentication embodiment, the system would be operative for the collection and search of biometric information upon startup. It should also be noted that on operator-authenticated embodiments, the operator need not be physically co-located with the first computing component. Rather, operator authentication may take place remotely, such as authentication where credentials are sent over a secure internet connection with the first computing component. Lastly, the operator need not necessarily be a human person. Operator authentication may also take the form of control software having security controls that are trusted by all the participating organizations. Such software may require authentication much like a human operator, where each participating organization must authenticate the control software using PKI techniques before the system may be activated. Control software can be located on the computing component operatively connected to the biometric collector or remotely in communication with it, such as through a secure internet connection. The operator may also perform other administrative roles required for the set up and maintenance of the system, such as debugging and configuration updates.

The above components are described in greater detail below with reference to the figures. The descriptions below set forth the various processes, relationships, and physical components of various embodiments of the subject matter of this specification.

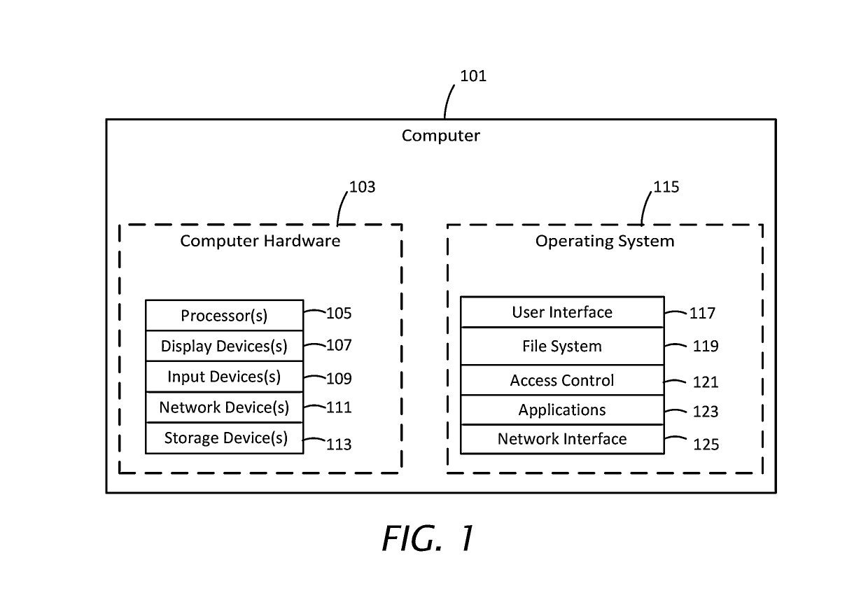

FIG. 1 is a system diagram depicting core physical functionality and operating system functionality of a computer. Computer hardware 103 consists of a processor(s) 105, display device(s) 107, input device(s) 109, network device(s) 111, and storage device(s) 113. The operating system software 115 manages computer hardware resources and dictates the execution of all other software programs and processes. The operating system additionally controls the user interface 117, file system and memory management 119, access control 121, user applications 123, and network interface 125 of a functioning computer. The operating system can be multi-user, multiprocessing, multitasking, multithreading, real-time, and the like. The operating system performs basic tasks, including but not limited to: recognizing input from input device(s); sending output to display device(s); and keeping track of files and directories on storage device(s). The operating system includes various components for establishing and maintaining network connections (e.g., software for implementing communication protocols, such as TCP/IP, HTTP, Ethernet, USB, FireWire® protocols, etc.).

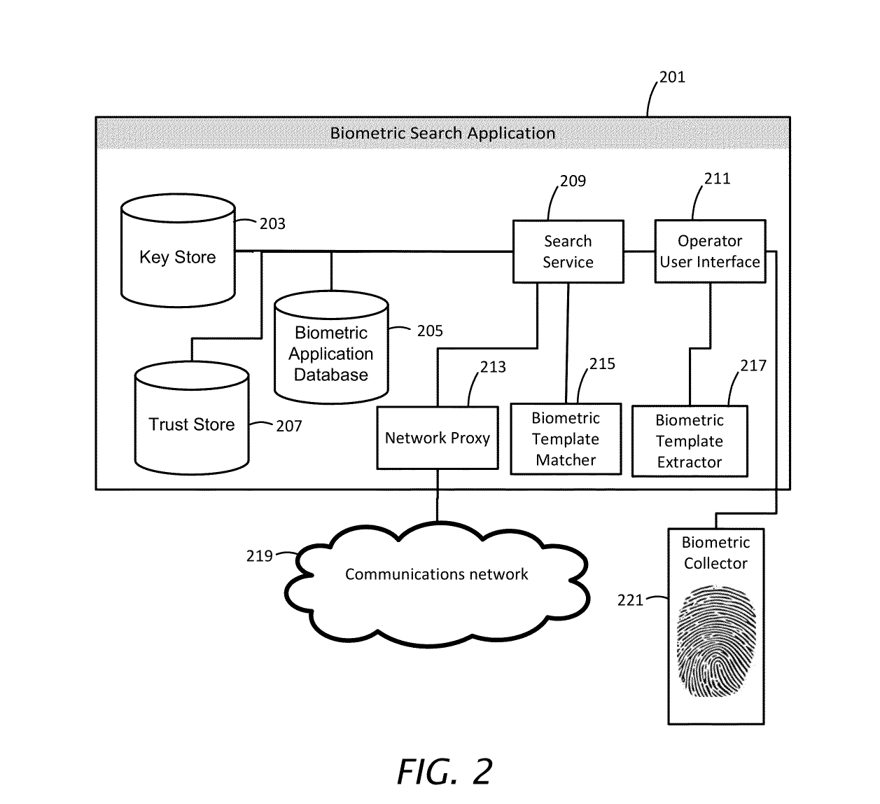

FIG. 2 is a system diagram depicting an embodiment showing functional components of the biometric search application 201. In this embodiment the biometric search application executes over a plurality of computing components. The biometric search application contains an operator user interface 211 that provides an interface for collecting biometric data, performing biometric searches, validating and managing PKI certificates, and configuring local and remote biometric application databases. The operator user interface also manages biometric template extraction using the biometric template extractor 217 and provides an interface to all supported biometric collectors 221.

The search service 209 implements the functionality for searching biometric templates using the biometric template matcher 215 and for communicating with remote computer components using the network proxy 213. The network proxy interfaces with the operating system and network interface using standard operating system function calls supporting network protocol (e.g. TCP/IP, etc.) or web service protocol (e.g. SOAP, JSON, REST, etc.). The biometric application database 205 is used to store configuration settings and one or more encrypted biometric application databases. The key store 203 is used to securely store certificates that contain both public and private keys. The trust store 207 is used to securely store certificates that only contain public keys. In some embodiments, the key store and trust store are implemented as encrypted databases, in other embodiments the key store and trust store are stored in an external smart card, USB token, or other external hardware key store device. In other embodiments, the key store and trust store are implemented in the operating system. Examples of such implementations include Microsoft Windows certificate manager or Android CertStore.

In some embodiments, the search service is implemented as background service that is configured to start when the operating system is started and run in the background as long as the computing component is running. In other embodiments, the search service is implemented as a system tray application (e.g., hidden application that is only visible on the taskbar) that is also configured to start when the operating system is started and run in the background as long as the computing component is running.

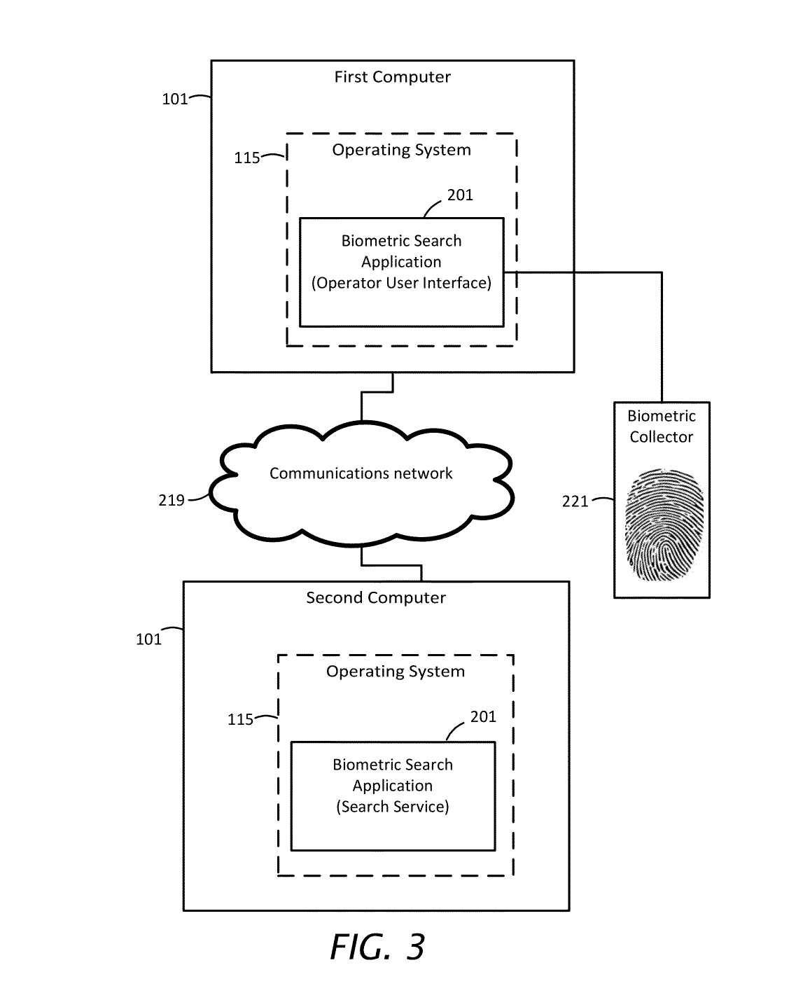

FIG. 3 is a system diagram depicting an embodiment of the subject matter of this specification implemented across a plurality of computing components, wherein each computing component is a computer. The first computer 101, contains tangible computer hardware including processor(s), display device(s), input device(s), network device(s), and storage device(s). The first computer is running an operating system 115 and biometric search application 201 that contains a user interface that allows an operator to conduct a biometric search on a subject and display the results. A biometric collector 221 is operatively connected to the first computer to capture raw biometric information. A communications network 219 connects all computing components allowing data to be sent back and forth to the first computer. The second computer 101 functions similarly to the first computer with a similar operating system 115, with the exception that the biometric search is performed as a background process as opposed to an end-user application with a graphical user interface. One or more computers can be connected to the first computer. Multiple computers offer the ability to intensify performance and increase storage capability. For example, a single participating organization may desire to break up its biometric application database into multiple parts implemented on multiple computing components. These smaller biometric application databases would then function as separate participating organizations in the system and accordingly be searched in parallel.

FIG. 4 is a system diagram depicting an embodiment of the subject matter of this specification implemented across a plurality of computing components, wherein each computing component is a virtual machine. Computer 101 contains tangible computer hardware including processor(s), display device(s), input device(s), network device(s), and storage device(s). Instead of the operating system acting on physical hardware, the computer runs a collection of virtual operating systems implemented on virtual machines being managed by a hypervisor 401. The hypervisor can regulate a plurality of virtual operating systems and is only constrained in number of virtual machines by hardware capability. The first virtual machine 403 contains the user interface that allows a user to login and access the operating system 115 of that virtual machine. Implemented via the first virtual machine's operating system is the main biometric search application 201 that conducts a biometric search on a subject. Biometric collector 221 is operatively connected to the first virtual machine to capture raw biometric information. The second virtual machine 403 functions similarly to the first virtual machine with a similar operating system 115, with the exception that the biometric search application 201 is performed as a background process as opposed to an end-user application with a graphical user interface. The hypervisor can regulate a plurality of virtual operating systems and is only constrained in number of virtual machines by hardware capability. As such, additional computing components may be added as virtual machines. The set of computing components are operatively connected to one another by a virtual communication network 405 that is configured and managed using the hypervisor and operating systems of each computing component.

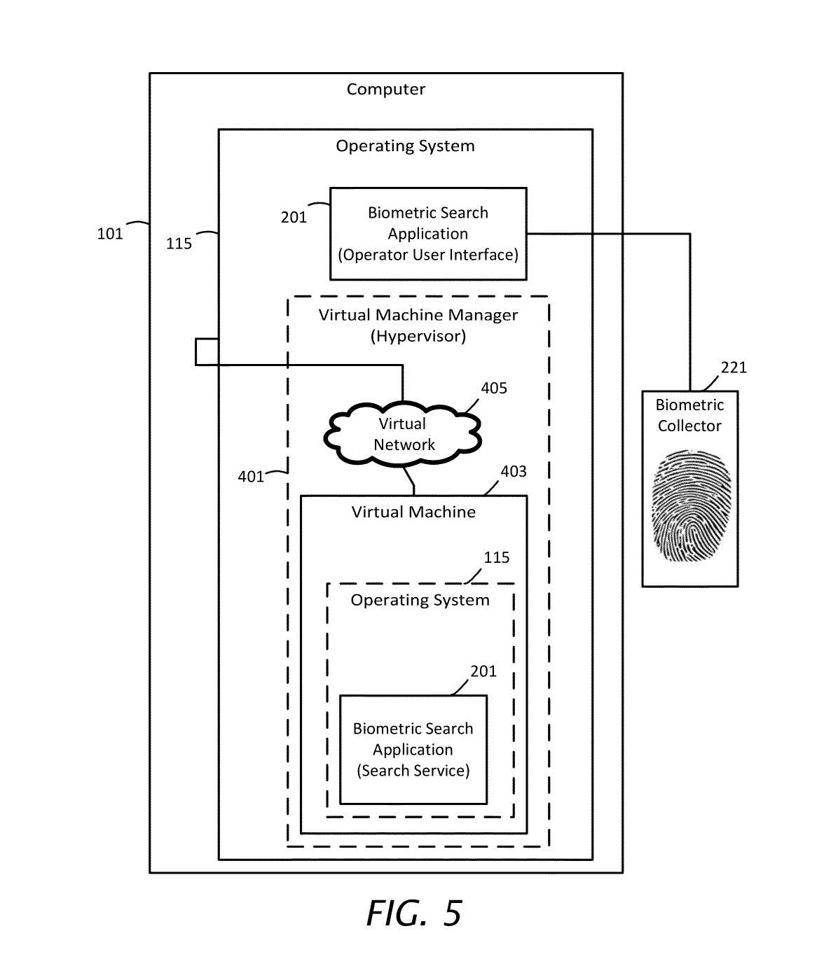

FIG. 5 is a system diagram depicting an embodiment of the subject matter of this specification implemented across a plurality of computing components, wherein one computing component is a computer and a second computing component is a virtual machine. Computer 101 contains tangible computer hardware including processor(s), display device(s), input device(s), network device(s), and storage device(s). The operating system 115 acts on the physical hardware of the computer and runs the main biometric search application 201 that conducts a biometric search on a subject. Biometric collector 221 is operatively connected to the computer and interfaces with the main biometric search application to capture raw biometric information. The computer is also running a virtual machine being managed by a hypervisor 401. The virtual machine 403 functions similarly to the computer with a similar operating system 115, with the exception that the biometric search application 201 is performed as a background process as opposed to an end-user application with a graphical user interface. The hypervisor can regulate a plurality of virtual operating systems and is only constrained in number of virtual machines by hardware capability. As such, additional computing components may be added as virtual machines. A virtual network 405 enables communications between each of the computing components.

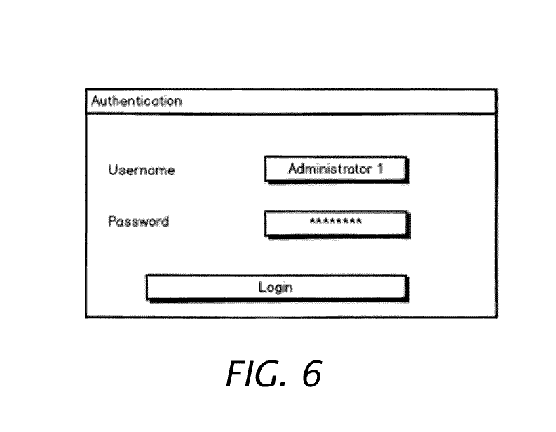

FIG. 6 is a screen mockup of an embodiment showing an operator authentication user interface that controls access to the biometric search application and operator user interface. In some embodiments, operator authentication is controlled directly by the operating system. This allows the participating organizations to leverage the full access control and user rights features of the operating system such as Microsoft Windows domain based user groups, roles, and user accounts. In other embodiments, the operator user interface permits access control directly via the application. This approach can be used to support authentication control for operating systems that do not support complex access control management such as the Android and Apple Iphone operating systems. As discussed above the login can employ a range of authentication techniques, including a single factor username and password, or two factor authentication requiring both a username and password as well as a collected factor such as a fingerprint or a supplied hardware token that is stored on a USB dongle.

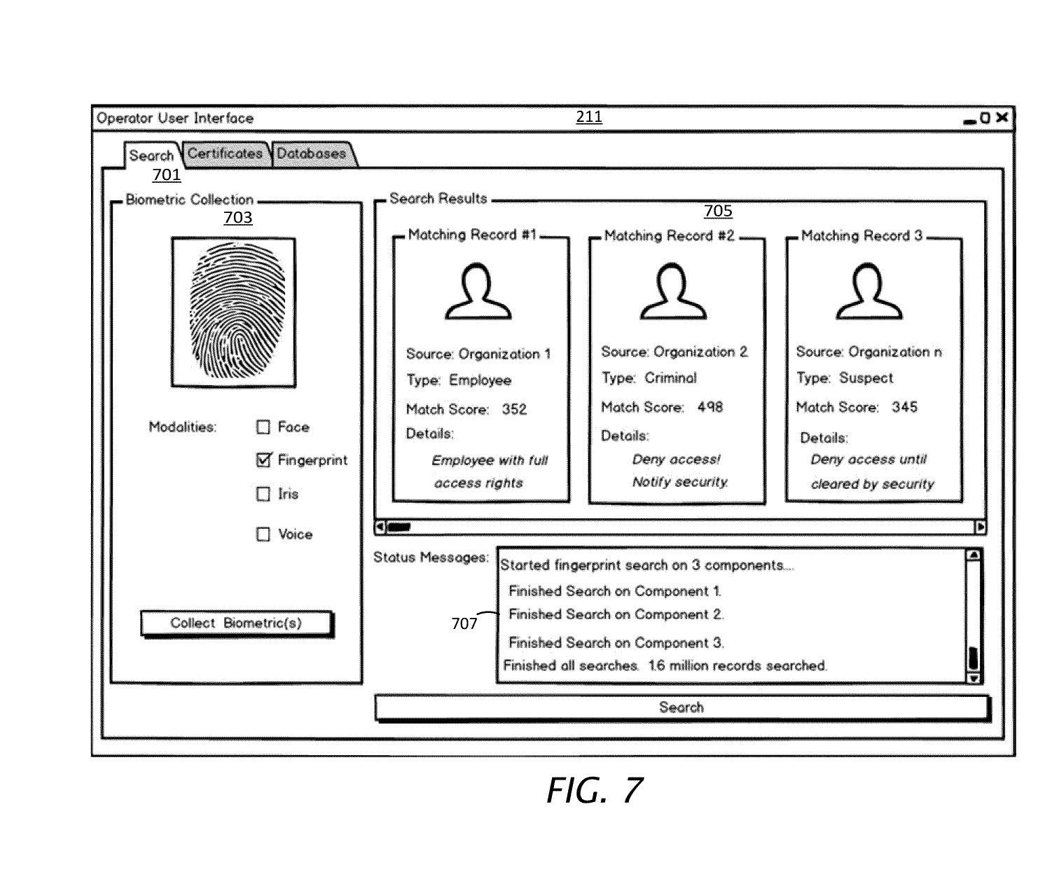

FIG. 7 is a screen mockup of an embodiment showing the operator user interface 211 of the biometric search application for submitting biometric searches and viewing the returned search results. The search tab 701 provides a biometric collection pane 703 where the operator selects the biometric modalities to collect from the subject and activates a button to collect the modalities. In other embodiments this functionality will support automated (e.g., batch mode) collection of biometric information from files or streaming near real-time collected biometric content such as video face capture or near-real time iris collection (e.g., iris on the move). After collecting biometric information the local and remote searches are performed and the search results from local and remote components are displayed in the search results pane 705. Local searches are biometric searches performed by the computing component operatively connected to the biometric collector. Remote searches are those biometric searches that take place against biometric application databases associated with computing components other than the computing component that is operatively connected to the biometric collector. The search results for each match may consist of a range of information, including face photo, contextual information regarding the matching biometric and source, a quality score indicating how closely the biometric templates matched, and details regarding what access rights and limitations the matching person has been assigned. During each local and remote search, status messages 707 are displayed to provide the user with near real-time status information such as when each search component is finished performing a search and how many records were searched.

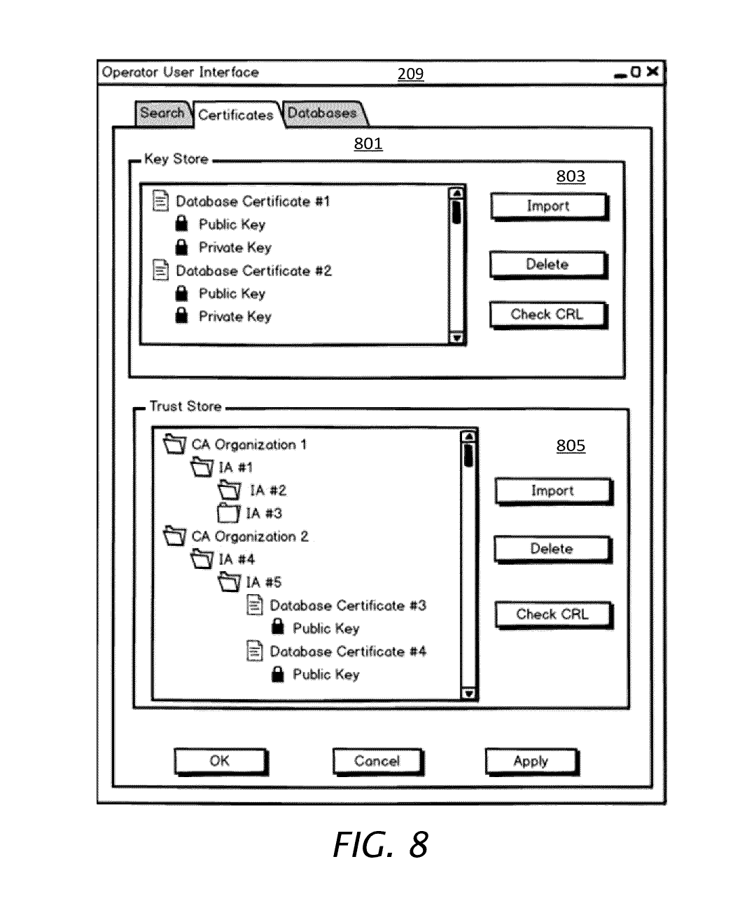

FIG. 8 is a screen mockup of an embodiment depicting the operator user interface 209 for managing PKI certificates that are used to support local and remote biometric searches. The certificates tab 801 comprises of two panes, a key store pane 803 and a trust store pane 805. The key store pane provides functionality for managing the database certificates that contain the private key used to decrypt and assess the biometric data stored locally on a computing component in the biometric application database 205. Those database certificates are stored in the key store 203. The functionality for managing the trust store is provided in the trust store pane. This pane manages certificates that contain only public keys including database certificates for remote searches. Intermediate certificates and certificate authority (i.e., root) certificates are stored in the trust store 207. Both the key store pane and trust store pane provide functionality for importing and deleting certificates from the key store and trust store, and functionality for validating certificates as described further below.

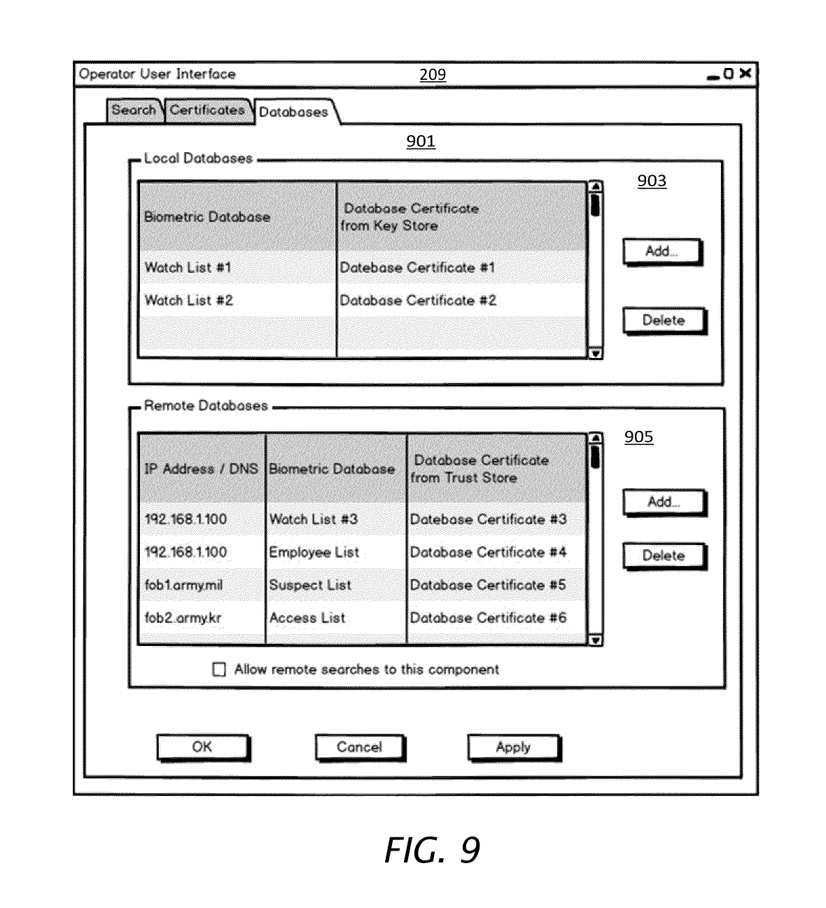

FIG. 9 is a screen mockup of an embodiment depicting the operator user interface 209 functionality for configuring local and remote biometric application databases. The databases tab pane 901 contains a local databases pane 903 that supports the addition and deletion of local databases of biometric templates that can be searched locally within the given computing component. Each database is associated with a database certificate that has been stored in the computing component's key store 203 and has been encrypted using the associated database certificate's private key. Each database is associated by the filename or other unique identifier of the database with a database certificate. The remote databases tab pane 905 supports the addition and deletion of remote database associations that can then be referenced for searches on other computing components. The operator can also specify that all remote searches are disabled. Each remote computing component is identified by a unique network identifier such as but not limited to network IP address or DNS name. In some embodiments, the network identifier may be a MAC address of computer network device 111 or a combination of multiple identifiers such as but not limited to MAC address, IP address or DNS name.

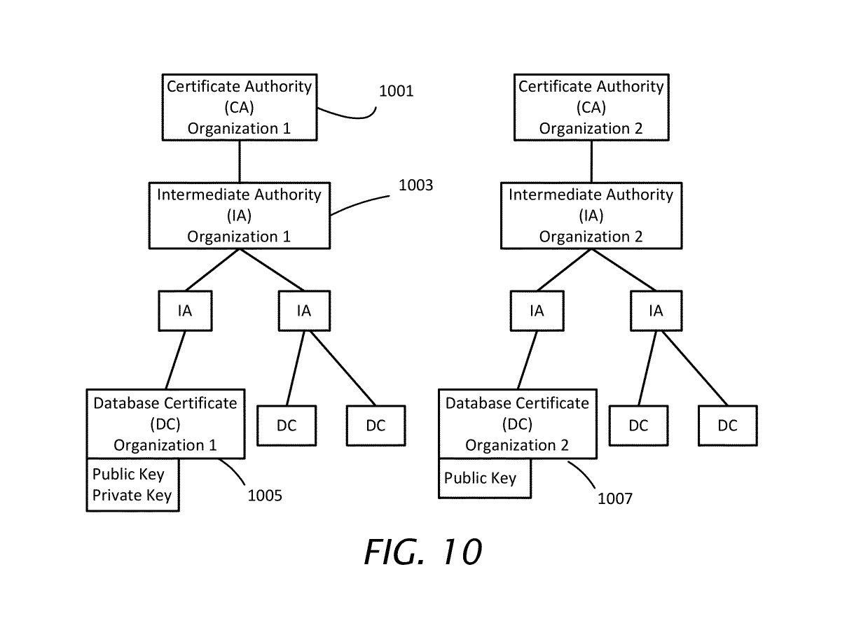

FIG. 10 is a system diagram depicting an embodiment of the PKI certificate hierarchies in the form of a tree structure for two different participating organizations. Each organization has one certificate authority certificate 1001 (also known as a “root certificate”), and one or more database certificates 1005 and 1007. Each hierarchy may also consist of multiple intermediate certificates 1003. Each certificate in the tree structure inherits the trustworthiness of the root certificate. Certificates further down each tree depend on the trustworthiness of the intermediate certificates. In the depicted embodiment, database certificates 1005 that are associated with a local computing component's encrypted biometric application database are stored in the key store 203 saving both the private and public keys while database certificates 1007 that are associated with a remote biometric application database (i.e., a watch list stored on a storage device operable by a computing component) are shared and import only the public key. In some embodiments, the public key infrastructure and public/private key pairs will be based on the X.509 ITU Telecommunication Standardization Sector standard, which specifies, amongst other things, standard formats for public key certificates, certificate revocation lists, attribute certificates, and a certification path validation algorithm. An X.509 based public certificate commonly contains information identifying the owner of the certificate, an identifier of the central authority that issued the certificate, a unique serial number, a validity date range, and other optional fields that indicate how the certificate can be used. In addition to this information, a X.509 certificate contains information needed to verify the integrity of the certificate such as a public key that is owned by the certificate owner and a field describing the hash and encryption functions used to create the digital signature (e.g., thumbprint) of the certificate. The digital signature is an encrypted one way hash of the certificate contents. This signature is created using the private key of either the certificate owner or, for certificates issued by an intermediate or root certificate, the private key of the intermediate or root certificate.

Certificate validation commonly involves verifying that the start and expiration date stored in the certificate are valid and have not expired and that the certificate format is valid and does not contain information fields that are improper or invalid. The certificate's digital signature is compared to a calculated hash of the certificate using the certificate's public key to verify that the certificate has not been tampered with or corrupted.

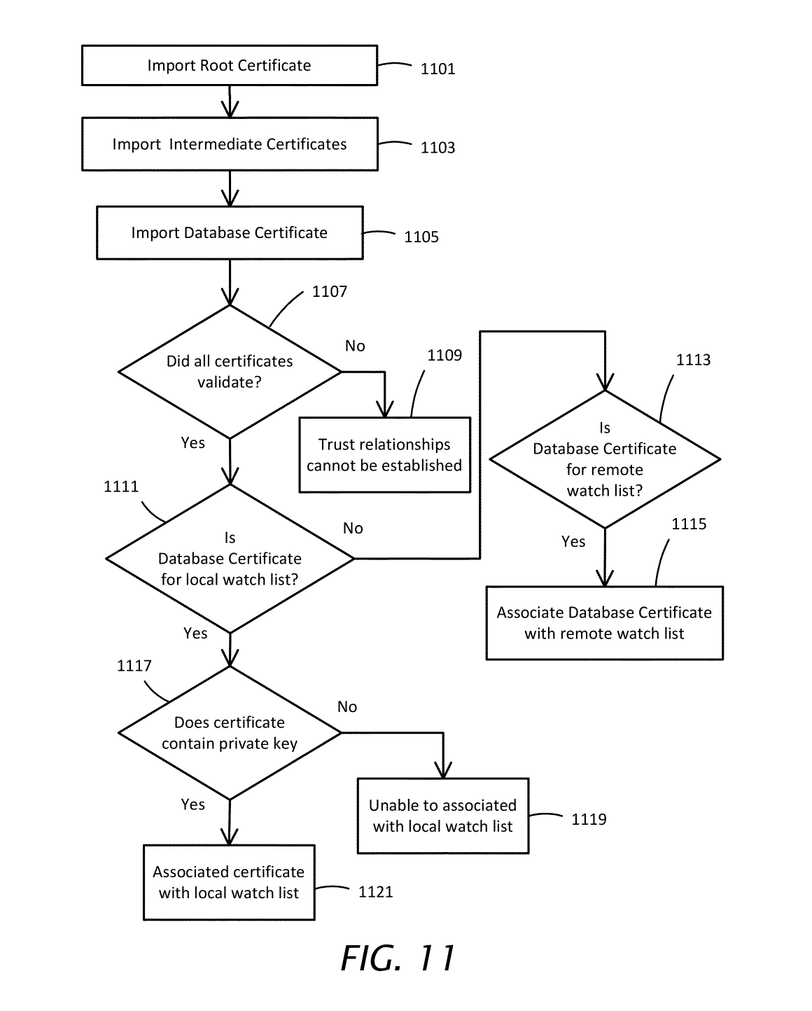

FIG. 11 is a flow diagram depicting a validation subroutine for validating and associating PKI database certificates with local and remote biometric application databases. Before a database certificate can be validated the trusted root certificate and each intermediate certificate need to be imported into the certificate trust store. In some embodiments the certificate trust store is provided by the operating system 115, in other embodiments the certificate trust store is stored directly in the trust store database 207. The first step of this process is the importation of the root certificate into the trust store 1101. If a trust store is not available in the basic operating system, one must be added. Once the root certificate has been imported into the trust store, it is then validated by commonly accepted certificate validation methods which typically include the establishment of an HTTPS connection to a certificate authority, transmission of a hash of the root certificate, and then a private key is used to verify that the hash is valid. Once this process is complete, the user can then import additional IMs 1103 using the same certificate validation process. This process is repeated for all required intermediate certificates. When all required intermediate certificates have been imported and validated, the database certificate 1105 is then imported and validated using the same certificate validation procedure. If all the certificates in the certificate chain 1107 did not pass validation then a trust relationship cannot be established 1109 with remote computing components. Also if all the certificates in the certificate chain did not pass validation then the database certificate cannot be trusted to unlock and search a local or remote watch list. If all the certificates in the certification chain did pass validation, then the imported database certificate can be associated with a local watch list or with a remote watch list. If the database certificate is to be associated with a local watch list 1111 then the system determines if the database certificate contains a private key 1117 by reading the certificate contents. If the certificate does not contain a private key, then the system is unable to associate it with a local watch list database 1119 because there is no way to decrypt the contents of the watch list and therefore be able access the stored biometric templates. If the database certificate contains a private key the system associates the watch list with the certificate by storing the association in the biometric application database 205.

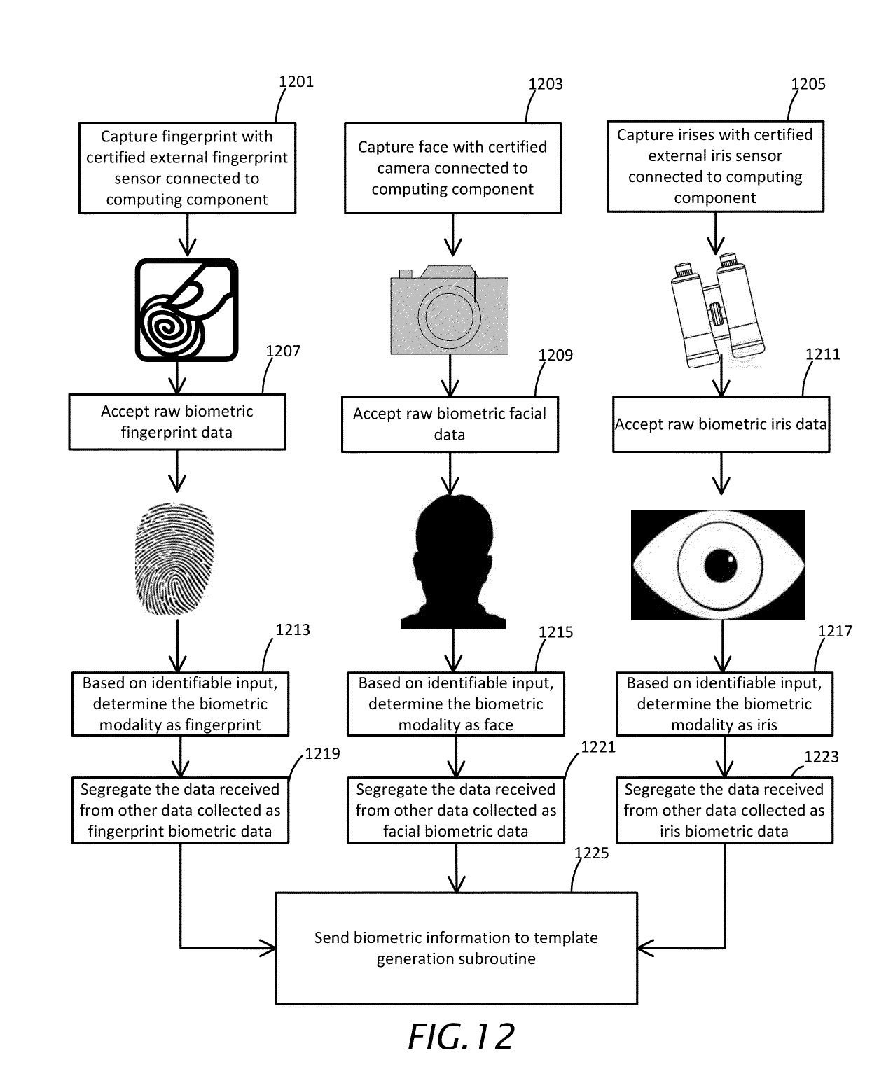

FIG. 12 is a flow diagram of an embodiment depicting a subroutine for the collection and segregation of biometric information of a subject. A simple collection would consist of collecting only one biometric modality from a subject. A segregated collection would consist of collecting a plurality of biometric modalities. FIG. 12 demonstrates a plurality of biometric modalities being collected by an accompanying biometric collector as in 1201, 1203, and 1205. The appropriate biometric collector must be operatively connected to a computing component and interface with the biometric search application. All data collected by the biometric collector is accepted as raw biometric data as in 1207, 1209, and 1211. The data received by a biometric collector may be associated with a particular data field, which will generally correspond to a specific biometric modality or a specific physical parameter of the biometric data collected (“type”). Data fields may be configured as needed by the nature of the biometric information required to be searched against. For example a biometric collector may collect a full set of ten-prints and have separate data fields for each finger collected as well as the set as a whole, or an imaging device may collect facial and iris information in a single collection but associate iris data as one data field and the facial data as a second data field. Based on these data fields, the type and modality of the biometric collected is determined as in 1213, 1215, and 1217.

After the data is collected, it is then segregated into subsets of biometric information associated with each biometric application database of the system as shown in 1219, 1221, and 1223. For example, there may be three entities controlling biometric application databases in the system. The first entity may have records associated with fingerprint biometrics, the second with facial biometrics, and the third with iris. In another example, all three participating organizations may control biometric application databases associated with fingerprint biometrics; however the first may only contain thumbprint data, while the other two contain full ten-print sets. In either example the original set of biometric information would be segregated into subsets consistent with the type and modality of biometric information associated with the biometric application databases of each participating organization. After segregation, the biometric information is sent 1225 to be generated into a biometric template using the appropriate template generation algorithm for that particular biometric type or modality.

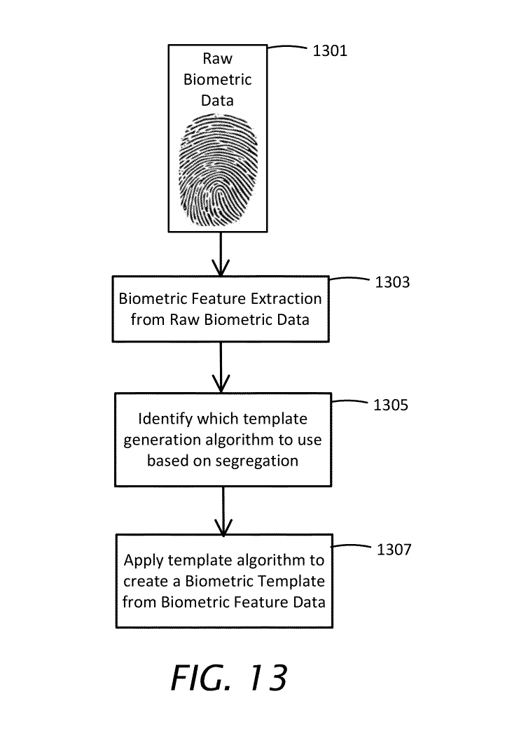

FIG. 13 is a flow diagram depicting a template creation subroutine executed by biometric template extractor 217. Raw biometric data 1301 such as a ten digit set of fingerprints is collected 1301 using a biometric collector. The minutiae that enable fingerprint identification are then extracted from the raw biometric data 1303. The template creation algorithm associated with the modality to be searched against is selected 1305 and applied to the extracted features 1307 to generate the applicable searchable template for the type or modality. Software implementing biometric template generation algorithms are well known in the art, including the CROSS MATCH® fingerprint template generator and Neurotechnology MEGAMATCHER™ fingerprint template generator.

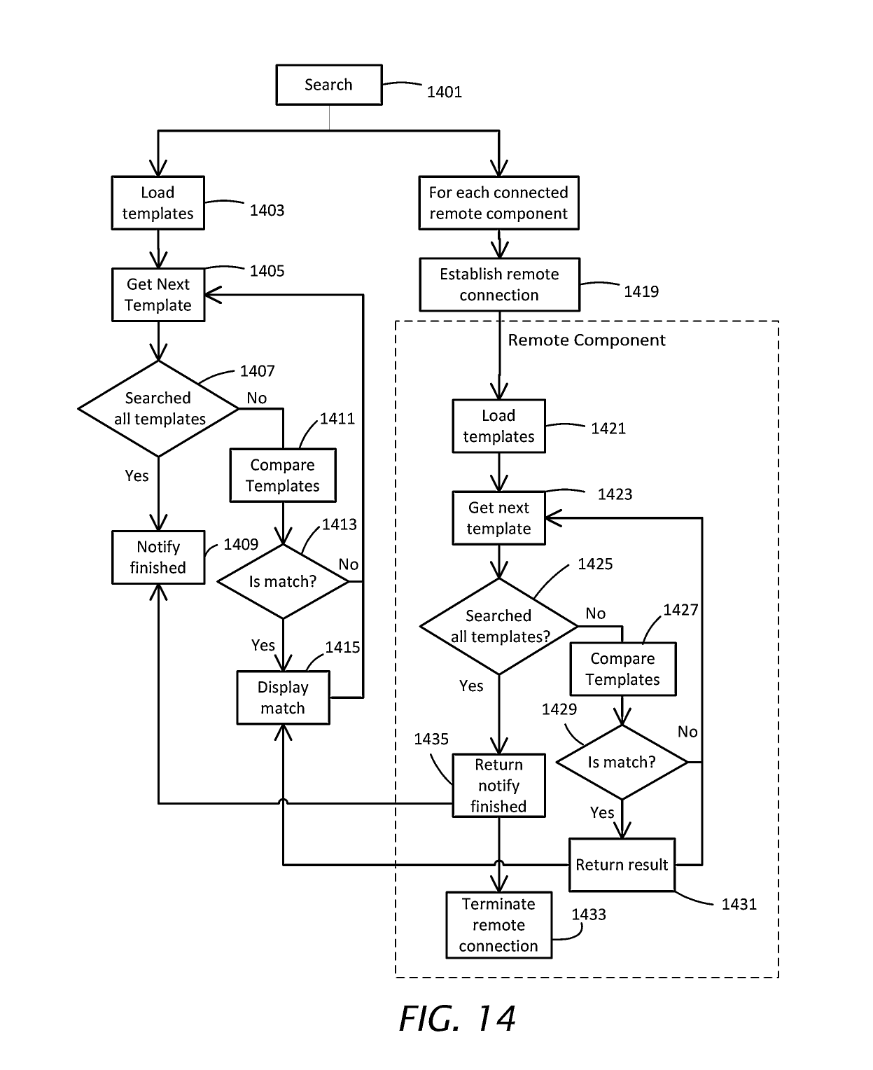

FIG. 14 is a flow diagram for an embodiment depicting a biometric search subroutine performed on a plurality of computing components. A search 1401 is initiated when one or more biometric templates are generated by the biometric template extractor 217. In the depicted embodiment the search service 209 supports multiple threads of execution and utilizes standard threading constructs (e.g. semaphores and locks, etc.) to prevent multithreaded execution issues such as reentry and race conditions between threads of execution. (Threads of execution are also known as “worker threads”). In this embodiment, the biometric template matcher 215 loads a list of biometric templates to search on the local computing component from the biometric application database 205 in step 1403. In some embodiments, the list of biometric templates is stored in application main memory which is managed by the operating system 115. Once all of the templates have been loaded 1403 into main application memory. The biometric template matcher 215 iterates through the list of all templates by getting each next template 1405 and then biometrically comparing the templates 1411. If a match 1413 is determined then the details of the matching record are displayed 1415 in the operator user interface 211 search results pane 705. If a match is not determined then the worker thread iterates through the next template in step 1405. This process is repeated until all templates in the local component have been compared to the collected templates. After all templates have been compared, the search service 209 notifies the operator user interface 211 that the local search has been completed 1409. This information is then reported to the user as a status message 707.

At the same time that the local search is being performed, the search service 209 utilizes the network proxy 213 to establish a remote connection 1419 to each remote computing component that is connected to the local computing component over either a physical network or virtual network. The established remote connection is validated and encrypted by using SSL or similar PKI techniques using the database certificate for the local component from the key store 203 and the database certificate that is associated with the remote computing component from the trust store. Mirroring the functionality of the biometric search that was performed on the local component, once the remote connection has been established, the remote biometric template matcher 215 loads a list of biometric templates 1421, iterates through the list of all templates by getting each next template 1423, and then biometrically comparing the templates 1427. If a match 1429 is determined then the details of the matching record, returned result 1431, is transmitted over the communications network to display the match details 1415 in the operator user interface 211 search results pane 705. If a match is not determined then the worker thread iterates through the next template in step 1423. This process is repeated until all templates in the remote computing component have been compared to the collected templates. After all templates have been compared the search service notifies the local computing component that the search is finished 1435 and then terminates the remote SSL connection 1433. Upon receiving the notify finished message from the remote computing component, the search service notifies the operator user interface that the specific remote search has been completed 1409 and this information is reported to the user as a status message 707.

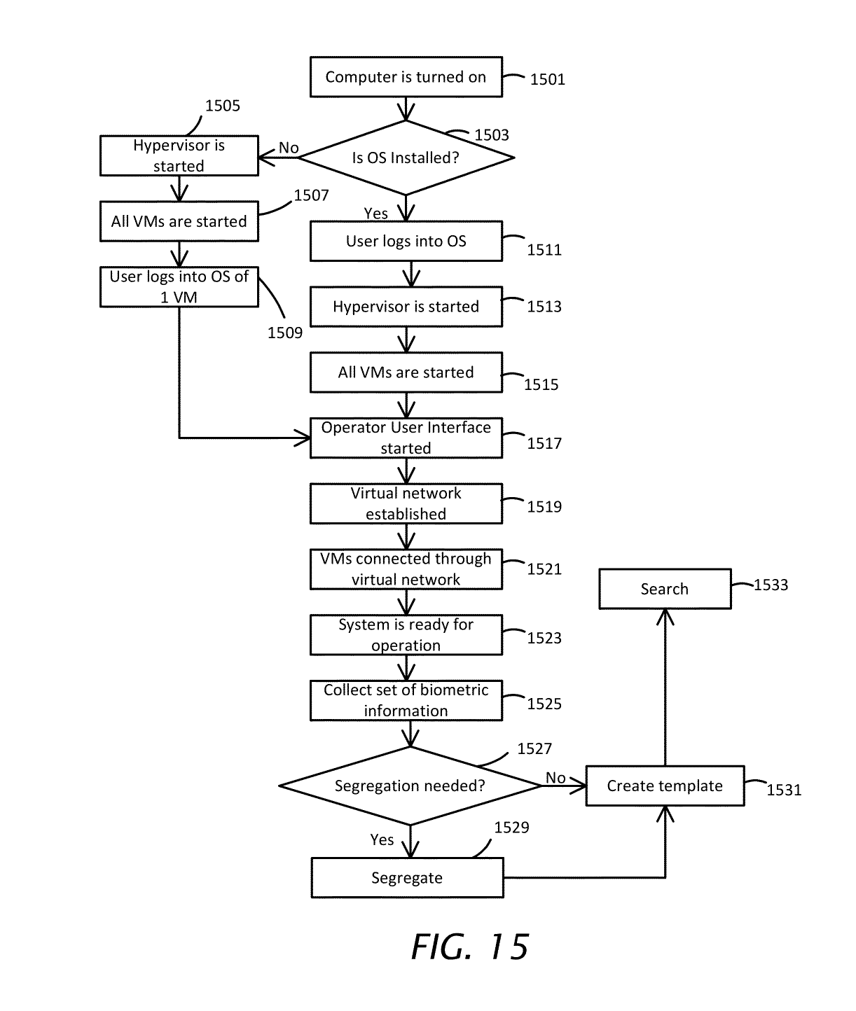

FIG. 15 is a flow diagram depicting an embodiment of the subject matter of this specification implemented over a plurality of computing components, wherein the computing components may be computers, virtual machines, or a combination of computers and virtual machines. The computer is activated 1501 and detects whether an operating system of a first virtual machine or computer is installed 1503. If the start-up routine of the computer has not automatically initiated a hypervisor is then started 1505. Once the hypervisor is operating, the operator starts all virtual machines that are to be used 1507, logs into one virtual machine 1509, and initiates the operator interface 1517. If the operating system was installed on the computer then the operator may login directly to the operating system 1511, the hypervisor program starts 1513, the operator stars all virtual machines that are to be used 1515, and initiates the operator interface 1517. The operator interface identifies all running virtual machines and forms a virtual local network 1519 that includes all computing components, including all running virtual machines 1521 as well as any computer. At this point, the system is ready for operation 1523.

As in the operation of other embodiments, the system collects a set of biometric information 1525. It is determined whether the collected biometric information needs to be segregated 1527 (e.g. if it contains multiple types or modalities), and if so it is segregated 1529. A template of each of the one or more subsets of biometric information is created 1531 and then encrypted as described elsewhere in the specification. Once encrypted templates for each of the one or more collected biometric subsets are created, the encrypted templates are searched 1533 against local and remote biometric application databases. The search may also be limited to only the computing component the operator is currently logged into. Encrypted results are then returned and the system is ready to collect another set of biometric information.

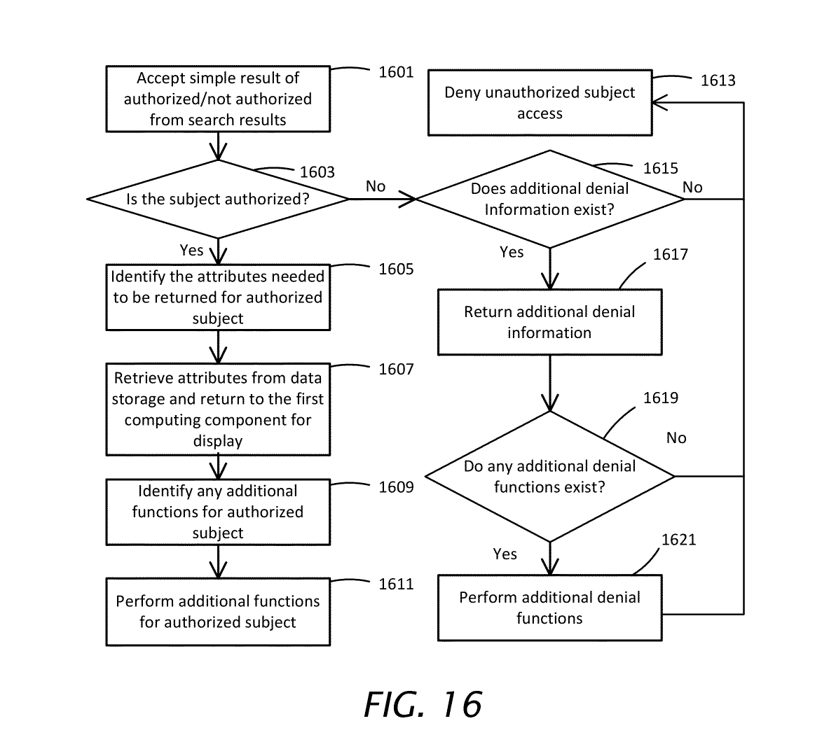

FIG. 16 is a flow diagram of a subroutine for the authorization or denial of a subject based on the result of a biometric search. A result of a biometric search is received signifying authorization or denial 1601. The subject will be deemed authorized or denied 1603 based on the received result. If a subject is authorized, attributes to be returned for that particular authorized subject are identified 1605. For example, if the system is implemented as an access control system for a facility, then a search result may return attributes such as “employee” with “full access rights” and admit the subject to the facility without conditions. Additional examples of such attributes are depicted in the search results pane 705. Attributes are retrieved from the biometric application databases 1607 and returned to the computing component where the search was initialized. Any further functions recognized for the particular authorized subject are identified 1609 and performed at 1611. For example, if the system returned the attributes “employee,” the system might perform the further function of updating other biometric checkpoints within the facility to admit the subject without further searching. A person of ordinary skill in the art will recognize the range of other functions that could be initiated within a greater system in which the subject matter of this specification is implemented.

Additional steps may be performed if a subject is denied authorization 1603. If a subject is unauthorized, additional denial of access information may attempt to be found 1615. For example the system may search related databases to determine if the subject has been denied access at any other locations, or if the subject is on any watchlist maintained by a participating organization. If additional denial information exists, attributes indicating this information may be returned at 1617 and may be presented on a user interface or used to trigger additional system functions. For example attributes such as “criminal” or “person of interest” may be returned. At 1619 additional denial functions are detected. These are functions that may be performed by the system as a response to the denial of access or returned denial information. Additional denial of access functions will then attempt to be retrieved 1619. If additional denial of access functions are recognized, the functions are performed 1621. Examples of such denial of access functions are activation of security processes that request appropriate security personnel to the area, cross checking of denied subject against other biometric identification systems, or requesting the entry of further identifying information such as a smart card, additional biometric information, or government issued credentials. The subject is then denied access as an unauthorized subject in accordance with the denial information and denial functions 1613. It should be noted that subject authorizations may automatically grant or deny access to a system or facility without interaction with a graphical user interface or operator involvement, such where the subject matter of this specification is implemented in a physical access control environment where subjects enter their biometric information and access gates open or remain closed based on the authorizations returned. Other automated implementations of the subject matter of this specification will be recognized by a person of ordinary skill in the art.

Embodiments of the subject matter of this specification solve the problems described in the background section by allowing biometric collection, identification, and verification to take place on a single device, while maintaining the security requirements of participating organizations. With specific regard to the South Korea example, the subject matter of this specification enables the parties to maintain both of their biometric application databases on a single physical machine. The U.S. database could be implemented directly on the computer, whereas the South Korean database could be implemented in an instance of a virtual machine operating on the computer. Each database would be encrypted and secured from the other, yet searchable by a single operator. The scope and content of search results could be tailored to the specific security needs of each country. Similarly, in another embodiment the South Korean computing component could be a computer, while the U.S. Forces computing component could be a remote computer operatively connected to the South Korean computer by means of a communications network. If the U.S. Forces ever became concerned about unauthorized access to their biometric application database, they could simply revoke the certificate authorities that enabled access by the South Korean computer.

The subject matter of this specification has applicability to a wide variety of practical contexts in addition to the application discussed above. For example, in addition to physical access control, the system may provide network access control. Participating organization may desire to participate in a single online payment system for all employees that enables independent employee account management. This would require verification of each employee before granting access. The system could provide this type of functionality, for example, through a computer handset application that collects biometric information and searches it against a federated set of databases of registered employees configured in accordance with the subject matter disclosed in this specification. Similar applications are found in hospital settings with respect to medical records or in law enforcement settings amongst federal and state or multi-national law enforcement agencies. Other applications and particular embodiments suitable for those applications will be recognized by a person of ordinary skill in the art.

The description of the subject matter of this specification has been presented for purposes of illustration and description, and is not intended to be exhaustive or limited to the form disclosed. Many modifications and variations will be apparent to those of ordinary skill in the art. The embodiments were chosen and described in order to best explain the principles of the system, practical applications, and to enable others of ordinary skill in the art to understand various embodiments with various modifications as are suited to the particular use contemplated.

1. A federated biometric verification system, comprising
a plurality of computers, each having a processor and a storage device, each operatively connected to each other, and each associated with one or more public/private key pairs;
at least one biometric collector operatively connected to the plurality of computers;
a plurality of databases, each stored in the storage device of a separate computer of the plurality of computers;
wherein a first computer of the plurality of computers stores the one or more public keys of each other computer of the plurality of computers, and each other computer of the plurality of computers stores the one or more public keys of the first computer;
a first program code executable by a processor of the first computer for:
collecting a set of biometric information from a subject through the at least one biometric collector,
encrypting, with the public key associated with each of the other computers, the set of biometric information,
transmitting each encrypted set of biometric information and a search request to each other computer associated with each applicable public key, and
decrypting the results received by each of the other computers with the public key of each of the other computers; and
a second program code executable by a processor of each other computer for:
decrypting the search request and biometric information transmitted by the first computer using the private key associated with each respective computer,
searching the set of biometric information against the database stored on each respective computer,
encrypting the results of the search with the public key of the first computer, and
transmitting the encrypted results to the first computer.

2. The system of claim one, wherein the first program code further comprises searching the set of biometric information against the database stored on the first computer and returning a result.

3. The system of claim one, wherein each database stores records of biometric information having a type and modality, and the first program code further comprises segregating the collected set of biometric information into subsets of biometric information that are compatible with the type and modality of biometric information applicable to each other database.

4. The system of claim one, wherein the results transmitted by each other computer are comprised of authorization attributes, and the first program code further comprises authorizing the subject in accordance with the authorization attributes transmitted by each other computer.

5. The system of claim one, wherein each database stores records of biometric information having a type, modality, and one or more templates, and the first program code further comprises segregating the collected set of biometric information into subsets of biometric information that are compatible with the type and modality of biometric information applicable to each other database and generating one or more templates that are compatible with the templates applicable to each other database.

6. The system of claim one, wherein the first program code further comprises authenticating an operator and initiating the system if the operator is authenticated.

7. A federated biometric verification system, comprising
a virtual machine monitor;
a plurality of computing components selected from the group consisting of a virtual machine and a computer, each of the plurality of computing components associated with one or more public/private key pairs, and each computer of the plurality of computing components having a processor and a storage device;
at least one biometric collector operatively connected to the plurality of computing components;
a plurality of databases, each stored in the storage device of a computer and each associated with a computing component;
wherein a first computing component of the plurality of computing components stores the one or more public keys of each other computing component of the plurality of computing components, and each other computing component of the plurality of computing components stores the one or more public keys of the first computing component;
a first program code executable by a processor operable by the first computing component for:
collecting a set of biometric information from a subject through the at least one biometric collector,
encrypting, with the public key associated with each of the other computing components, the set of biometric information,
transmitting each encrypted set of biometric information and a search request to each other computing component associated with each applicable public key, and
decrypting the results received by each of the other computing components with the public key of each of the other computing components; and
a second program code executable by a processor operable by each other computing component for:
decrypting the search request and biometric information transmitted by the first computing component using the private key associated with each respective computing component,
searching the set of biometric information against the database associated with each respective computing component,
encrypting a result of the search with the public key of the first computing component, and
transmitting the encrypted results to the first computing component.

8. The system of claim seven, wherein the first program code further comprises searching the set of biometric information against the database associated with the first computing component and returning a result.

9. The system of claim seven, wherein each database stores records of biometric information having a type and modality, and the first program code further comprises segregating the collected set of biometric information into subsets of biometric information that are compatible with the type and modality of biometric information applicable to each other database.

10. The system of claim seven, wherein the results transmitted by each other computing component are comprised of authorization attributes, and the first program code further comprises authorizing the subject in accordance with the authorization attributes transmitted by each other computing component.

11. The system of claim seven, wherein each database stores records of biometric information having a type, modality, and one or more templates, and the first program code further comprises segregating the collected set of biometric information into subsets of biometric information that are compatible with the type and modality of biometric information applicable to each other database and generating one or more templates that are compatible with the templates applicable to each other database.

12. The system of claim seven, wherein the first program code further comprises authenticating an operator and initiating the system if the operator is authenticated.

13. A federated biometric verification system, comprising
a single physical machine;
a virtual machine monitor;
a plurality of computing components implemented on the single physical machine comprising a computer having a processor and a storage device and one or more virtual machines, each of the plurality of computing components associated with one or more public/private key pairs;
at least one biometric collector operatively connected to the plurality of computing components;
a plurality of databases, each stored in the storage device of the computer and each associated with a computing component;
wherein a first computing component of the plurality of computing components stores the one or more public keys of each other computing component of the plurality of computing components, and each other computing component of the plurality of computing components stores the one or more public keys of the first computing component;
a first program code executable by the processor for:
collecting a set of biometric information from a subject through the at least one biometric collector,
encrypting, with the public key associated with each of the other computing components, the set of biometric information,
transmitting each encrypted set of biometric information and a search request to each other computing component associated with each applicable public key, and
decrypting the results received by each of the other computing components with the public key of each of the other computing components; and
a second program code executable by the processor for:
decrypting the search request and biometric information transmitted by the first computing component using the private key associated with each respective computing component,
searching the set of biometric information against the database associated with each respective computing component,
encrypting the results of the search with the public key of the first computing component, and
transmitting the encrypted results to the first computing component.

14. The system of claim thirteen, wherein the first program code further comprises searching the set of biometric information against the database associated with the computer and returning a result.

15. The system of claim thirteen, wherein each database stores records of biometric information having a type and modality, and the first program code further comprises segregating the collected set of biometric information into subsets of biometric information that are compatible with the type and modality of biometric information applicable to each other database.

16. The system of claim thirteen, wherein the results transmitted by each other computing component are comprised of authorization attributes, and the first program code further comprises authorizing the subject in accordance with the authorization attributes transmitted by each other computing component.

17. The system of claim thirteen, wherein each database stores records of biometric information having a type, modality, and one or more templates, and the first program code further comprises segregating the collected set of biometric information into subsets of biometric information that are compatible with the type and modality of biometric information applicable to each other database and generating one or more templates that are compatible with the templates applicable to each other database.

18. The system of claim thirteen, wherein the first program code further comprises authenticating an operator and initiating the system if the operator is authenticated.

19. A method for federated biometric verification performed by a processor operable by a first computing component, comprising:
collecting a set of biometric information from a subject through at least one biometric collector,
encrypting, with a public key associated with each of one or more other computing components, the set of biometric information,
transmitting each encrypted set of biometric information and a search request to each other computing component associated with each applicable public key, and
decrypting the results received by each of the other computing components with the public key of each of the other computing components; and
a method performed by a processor operable by each other computing component for:
decrypting the search request and biometric information transmitted by the first computing component using a private key associated with each other respective computing component,
searching the set of biometric information against a database associated with each other respective computing component,
encrypting the results of the search with a public key of the first computing component, and
transmitting the encrypted results to the first computing component.

20. A non-transitory computer-readable storage medium encoded with a first computer program code, the first computer program code executable by a processor operable by first computing component, comprising:
collecting a set of biometric information from a subject through at least one biometric collector,
encrypting, with a public key associated with each of one or more other computing components, the set of biometric information,
transmitting each encrypted set of biometric information and a search request to each other computing component associated with each applicable public key, and
decrypting the results received by each of the other computing components with the public key of each of the other computing components; and
a second program code executable by a processor operable by each other computing component for:
decrypting the search request and biometric information transmitted by the first computing component using a private key associated with each other respective computing component,
searching the set of biometric information against a database associated with each other respective computing component,
encrypting the results of the search with a public key of the first computing component, and
transmitting the encrypted results to the first computing component.
